(19) United States
(12) Patent Application Publication
(10) Pub. No.: US 2008/0207275 A1
(43) Pub. Date: Aug. 28, 2008

(54) Eyeglasses having a Bluetooth wireless earphone which plays MP3 music

(76) Inventors: Tai-Yih Lin, Taipei City (TW); Yu-Syuan Chen, Taipei City (TW)

Correspondence Address: PRO-TECHTOR INTERNATIONAL SERVICES, 20775 NORADA CT., SARATOGA, CA, 95070, US

(21) Appl. No.: 11/710,279

(22) Filed: Feb. 22, 2007

(51) Int. Cl. H04M 1/00

(52) U.S. Cl. 455/569.1

(57) ABSTRACT

A pair of eyeglasses having a Bluetooth wireless earphone which plays MP3 music is provided with a Bluetooth wireless earphone or a Bluetooth earphone with a built-in MP3 player which is fixed on a stand of an eyeglass frame by absorption with magnets, locking with locking buttons, or clipping with a clip.

### BACKGROUND OF THE INVENTION

a) Field of the Invention

The present invention relates to a pair of eyeglasses having a Bluetooth wireless earphone which plays MP3 music, and more particularly to a pair of eyeglasses which can be freely installed with a Bluetooth wireless earphone with an MP3 player.

b) Description of the Prior Art

Referring to FIG. 1, a conventional Bluetooth wireless earphone 100, or a Bluetooth earphone with a built-in function for playing MP3 music is directly fixed at a front end of a stand of a pair of eyeglasses for assembling with a frame 300. To facilitate a use of this Bluetooth earphone 100, an end of which is provided with a soft earphone line 101 for connecting to an earphone 102, and the stand 200 is provided with an earphone slot 201 for latching and positioning the earphone 102.

However, as the aforementioned Bluetooth wireless earphone 100 or the Bluetooth earphone with the built-in MP3 player, which is used in a cellular phone, is assembled with the eyeglasses into one body, so as to form a fixed device that cannot be replaced. If the Bluetooth wireless earphone 100 or the Bluetooth earphone with the built-in function for playing the MP3 music is malfunctioning, it cannot be dismantled from the frame 300, and the whole eyeglasses should be delivered for repairing. Therefore, if a user only wants to wear the glasses without employing the Bluetooth wireless earphone 100, he or she is not able to take down the 1. Bluetooth wireless earphone 100 independently.

### SUMMARY OF THE INVENTION

The primary object of present invention is to provide a pair of eyeglasses such that a Bluetooth wireless earphone or a Bluetooth earphone with a built-in MP3 player, which is used in a cellular phone, can be quickly and firmly installed on a stand of the eyeglasses, thereby being provided with a special effect of a quick and easy installation and dismantlement.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a general view of a conventional product.

FIG. 2 shows a general view according to the present invention.

FIG. 3 shows a schematic view of absorption with magnets according to the present invention.

FIG. 4 shows a schematic view of a locking with locking buttons according to the present invention.

FIG. 5 shows a schematic view of a fixing with a clip according to the present invention.

FIG. 6 shows a schematic view of a locking with screws according to the present invention.

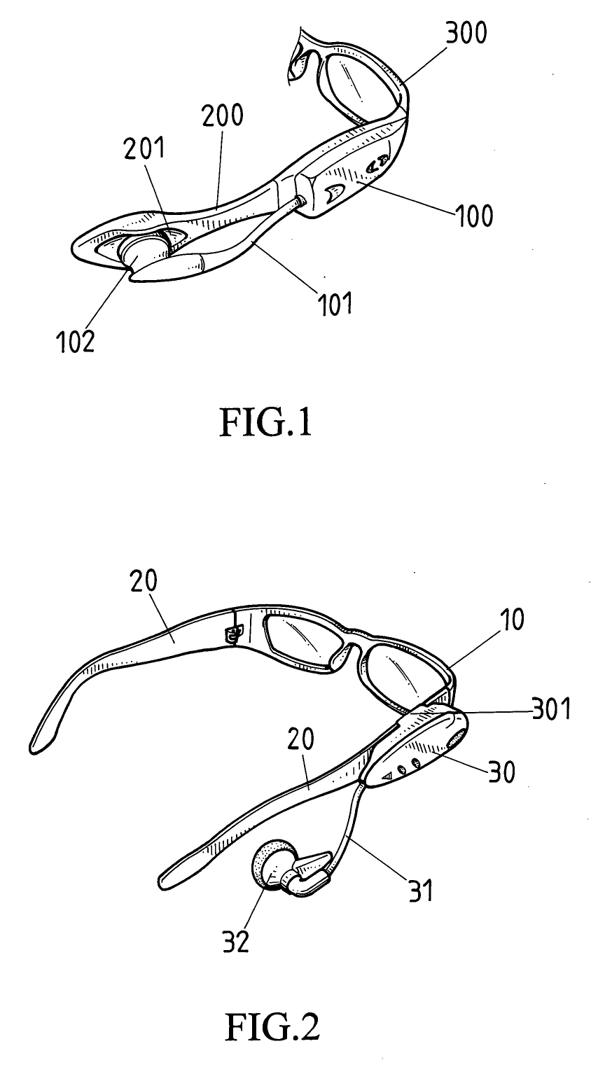

### DETAILED DESCRIPTION OF THE PREFERRED EMBODIMENTS

Referring to FIG. 2, an eyeglass frame 10 of the present invention is pivoted with two stands 20 into one body, and a Bluetooth wireless earphone 30 or a Bluetooth earphone with a built-in MP3 player can be quickly installed on one of the stands 20. An interior of the Bluetooth wireless earphone 30 is emplaced with chips and a battery accessory, and an earphone line 31 at an end of the earphone 30 is connected to an earphone 32. Moreover, a top end at a side of the Bluetooth wireless earphone 30 is provided with a projected object 301 which can hook an upper end of the stand 20 to prevent the Bluetooth wireless earphone 30 from dropping off during a process of absorption or locking, thereby increasing robustness.

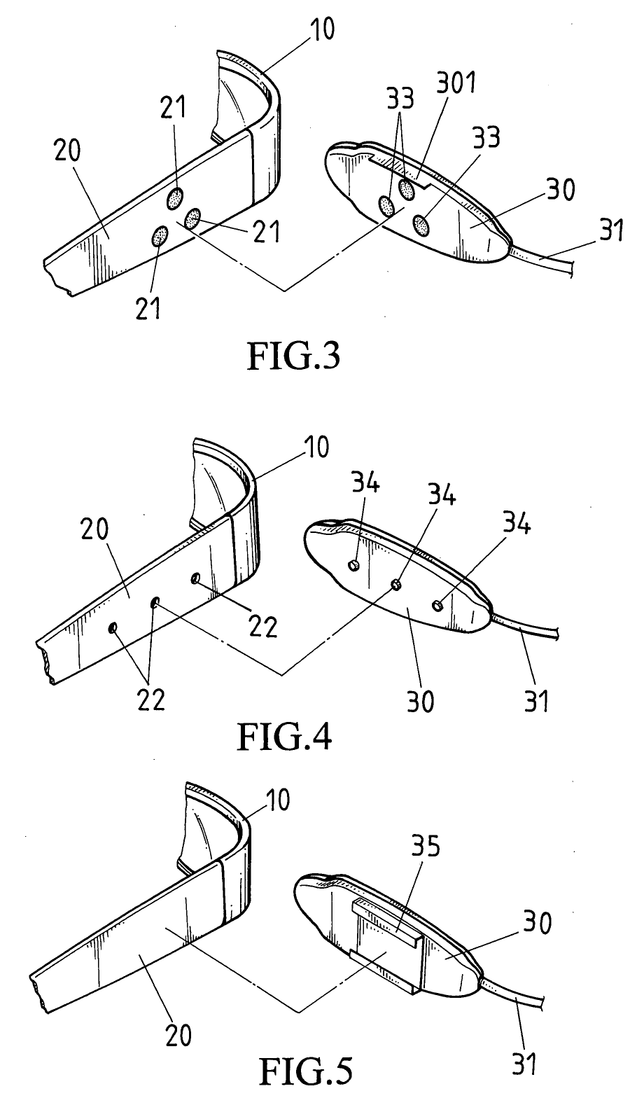

Referring to FIG. 3, one stand 20 of the frame 10 is inlaid with at least one powerful magnet 21, and the Bluetooth wireless earphone 30 having an MP3 player is also provided with at least one powerful magnet 33. The button-shape magnets 21, 33 of the two devices can absorb mutually, so as to quickly and firmly fix the Bluetooth wireless earphone 30 or the Bluetooth earphone with the built-in MP3 player on one stand 20.

Referring to FIG. 4, in addition that the stand 20 of frame 10 and the Bluetooth wireless earphone 30 are installed with the magnetic elements, the stand 20 is also provided with at least one locking hole 22, and the Bluetooth wireless earphone 30 or the Bluetooth earphone with the built-in MP3 player is also provided with at least one locking button 34 which can be locked into the locking hole 22 of one stand 22 of the frame 10 for positioning, so as to reinforce robustness in assembling.

Referring to FIG. 5, in addition to that one stand 20 of the frame 20 and the Bluetooth wireless earphone 30 are installed with the magnetic elements, the Bluetooth wireless earphone 30 or the Bluetooth earphone with the built-in MP3 player is also provided with a U-shape clip 35 which can be clipped on one stand 20 of the frame 10 to fix the Bluetooth wireless earphone 30 on one stand 20.

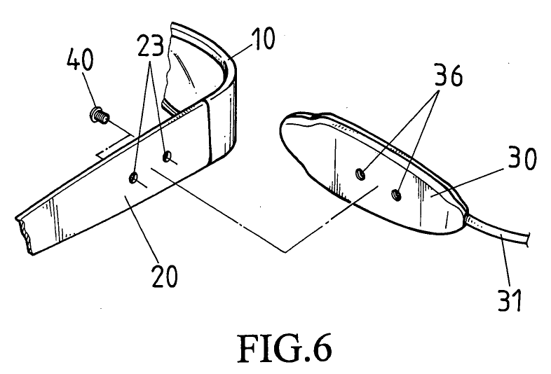

Referring to FIG. 6, in addition to that one stand 20 of the frame 20 and the Bluetooth wireless earphone 30 are installed with the magnetic elements, two screws can be transfixed into two through-holes 23 of the stand 20 to be locked into two screw-holes 36 of the Bluetooth wireless earphone 30 for positioning.

In conclusion, all kinds of the fixing methods are used in the present invention to directly fix the Bluetooth wireless earphone on one of the stands 20 of the eyeglasses, which is easy to install and dismantle, and can be even replaced by all kinds of different models of Bluetooth wireless earphones.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A pair of eyeglasses having a Bluetooth wireless earphone which plays MP3 music, comprising a Bluetooth wireless earphone which is installed on one of a left and right stands of an eyeglass frame, wherein the stand is installed with at least one magnet, and the Bluetooth wireless earphone is also installed with one magnet, such that the Bluetooth wireless phone is fixed on the stand by mutual absorption of the magnets.

2. The pair of eyeglasses having a Bluetooth wireless earphone which plays MP3 music, in accordance with claim 1, wherein one stand of the frame is added with at least one locking hole, and the Bluetooth wireless earphone is added with at least one locking button which is locked into the locking hole to fix the Bluetooth wireless earphone.

3. The pair of eyeglasses having a Bluetooth wireless earphone which plays MP3 music, in accordance with claim 1, wherein the Bluetooth wireless earphone is added with a U-shape clip which is clipped on one stand of the frame to fix the Bluetooth wireless earphone on one stand.

4. The pair of eyeglasses having a Bluetooth wireless earphone which plays MP3 music, in accordance with claim 1, wherein one stand of the frame is added with through-holes, and the Bluetooth wireless earphone is added with screw-holes, such that screws are transfixed into the through-holes of the stand to be locked into the screw-holes of the Bluetooth wireless earphone for positioning.

5. The pair of eyeglasses having a Bluetooth wireless earphone which plays MP3 music, in accordance with claim 1, wherein the Bluetooth wireless earphone is provided with a projected object which hooks an upper end of the stand to increase robustness.

6. The pair of eyeglasses having a Bluetooth wireless earphone which plays MP3 music, in accordance with claim 1, wherein the Bluetooth wireless earphone is also a Bluetooth earphone with a built-in MP3 player.
